(19) United States
(12) Patent Application Publication
(10) Pub. No.: US 2016/0202045 A1
(43) Pub. Date: Jul. 14, 2016

(54) METHOD OF MEASURING THE DEPTH OF PENETRATION OF A LASER BEAM INTO A WORKPIECE

(71) Applicant: PRECITEC OPTRONIK GMBH, Neu-Isenburg (DE)

(72) Inventors: Martin Schönleber, Aschaffenburg (DE); Markus KOGEL-HOLLACHER, Haibach (DE); Thibault BAUTZE, Karlsruhe (DE); Christian FRAAS, Winterthur (CH)

(21) Appl. No.: 15/075,970

(22) Filed: Mar. 21, 2016

Related U.S. Application Data
(63) Continuation of application No. PCT/EP2014/002483, filed on Sep. 13, 2014.

(30) Foreign Application Priority Data
Sep. 23, 2013 (DE) 10 2013 015 656.4

(51) Int. Cl. G01B 11/22; B23K 26/03; B23K 26/046; G01B 9/02

(52) U.S. Cl. CPC G01B 11/22; G01B 9/02091; B23K 26/03; B23K 26/046

(57) ABSTRACT

A method for measuring the penetration depth of a laser beam into a work-piece. A focusing optical unit arranged in a machining head focuses the laser beam in a focal spot. The focal spot produces a vapor capillary in the workpiece. An optical coherence tomograph produces a first and a second measurement beam. The first measurement beam is directed at a first measurement point at the base of the vapor capillary in order to thereby measure a first distance between a reference point and the first measurement point. At the same time, the second measurement beam is directed at a second measurement point on a surface of the workpiece which faces the machining head and which is outside of the vapor capillary measuring a second distance between the reference point and the second measurement point. The depth of penetration of the laser beam is the difference between the second and the first distances.

### CROSS-REFERENCE TO RELATED APPLICATIONS

This application is a continuation of, and claims benefit under 35 USC 120 to, international application PCT/EP2014/002483, filed Sep. 13, 2014, which claims benefit of German Patent Application No. 10 2013 015 656.4, filed Sep. 23, 2013. International application PCT/EP2014/00248 is hereby incorporated by reference in its entirety.

### BACKGROUND OF THE INVENTION

1. Field of the Invention

The invention relates to a method for measuring the depth of penetration of a laser beam into a workpiece, and also to a laser machining device by means of which workpieces can be welded, cut, drilled or machined in some other way.

2. Description of the Prior Art

Laser machining devices usually comprise a laser radiation source which may be, for example, a fiber laser or a disc laser. A laser machining device also includes a machining head which focuses the laser beam generated by the laser radiation source in a focal spot, and a beam-feeding apparatus which feeds the laser beam to the machining head. Under these circumstances, the beam-feeding apparatus may comprise optical fibers or other light guides and/or a number of deflection mirrors with plane or curved faces. The machining head may be fastened to a movable robotic arm or other traversing appliance which permits positioning in all three spatial directions. Under these circumstances, the laser radiation source is often arranged so as to be further away from the machining head or from a traversing appliance that carries the latter.

One problem in using laser machining devices which has so far still not been satisfactorily resolved consists in keeping the depth of penetration of the laser beam to the desired ideal value as accurately as possible. The depth of penetration is designated as the axial extent of the vapor capillary which is generated in the workpiece by the laser beam. Only if the depth of penetration assumes its ideal value can the desired machining result be achieved. If, in the welding-together of two metal plates for example, the depth of penetration is too small, no welding-together, or only incomplete welding-together, of the two plates occurs. Too great a depth of penetration, on the other hand, can lead to full-penetration welding.

Unwanted fluctuations in the depth of penetration can occur for different reasons. Thus, for example, a protective disc which protects the optical elements in the machining head against splashes and other contaminants may absorb an increasing portion of the laser radiation in the course of the laser machining operation, as a result of which the depth of penetration decreases. Also, non-homogeneities in the workpieces or fluctuations in the speed of traverse can lead to the depth of penetration varying locally and thereby deviating from its ideal value.

There have hitherto been no methods by means of which the depth of penetration of the laser beam can be reliably measured during the laser machining operation. This is connected with the fact that very difficult measuring conditions prevail inside the vapor capillary. Said vapor capillary is not only very small and emits an extremely bright light, thermally speaking, but in general also changes its shape constantly during the machining operation.

For this reason, its axial extent is, as a rule, deduced indirectly from observations of other quantities connected with the vapor capillary, for example its brightness. These values for the depth of penetration, which are estimated rather than measured, are compared with the ideal values. The output of the machining laser is then varied in a closed-loop control circuit in such a way that the depth of penetration approximates to its ideal value.

The use of optical coherence tomographs (OCT's) was suggested some time ago for distance measurement during laser machining; cf. in particular EP 1 977 850 A1, DE 10 2010 016 862 B3 and US 2012/0138586. Optical coherence tomography permits highly accurate and contactless optical distance measurement, even in the vicinity of the vapor capillary which emits a very bright light, thermally speaking, and which is generated in the workpiece by the laser beam in the area surrounding the focal spot. If the measuring beam is guided over the surfaces in a scanner-like manner, it is even possible to detect a 3-D profile of the surfaces scanned. If the measuring beam is directed into the vapor capillary, it is also possible, in principle, to measure the axial extent of said capillary as is described in US 2012/0285936 A1.

However, by means of an OCT measuring beam, which is guided, during the laser machining operation, in a scanner-like manner over the workpiece surface to be machined, the depth of penetration can be measured, during the laser machining operation, only with unsatisfactory accuracy. Closed-loop control of the depth of penetration by varying the laser output also suffers from this.

### SUMMARY OF THE INVENTION

The object of the invention is to provide a method by means of which the depth of penetration of a laser beam in a workpiece can be measured more accurately.

In one embodiment, this object is achieved by means of a method comprising the following steps:
a) focusing the laser beam in a focal spot with the aid of a focusing optical unit arranged in machining head, as a result of which the focal spot generates a vapor capillary in the workpiece;
b) generating a first measuring beam and a second measuring beam by means of an optical coherence tomograph;
c) directing the first measuring beam at a first measurement point in the vapor capillary, that is to say preferably at the base of said vapor capillary, in order to thereby measure a first distance between a reference point and the first measurement point;
d) at the same time as step c), directing the second measuring beam at a second measurement point on a surface of the workpiece which faces the machining head and which is outside of the vapor capillary, in order to thereby measure a second distance between the reference point and the second measurement point;
e) determining the depth of penetration of the laser beam from the first distance and the second distance.

The invention is based on the perception that it is only possible to measure the distance from the base of the vapor capillary with sufficient accuracy if a measuring beam of an optical coherence tomograph is directed permanently, or at least predominantly, into the vapor capillary. Under these circumstances, the significantly higher measuring accuracy is not only a consequence of the larger number of individual measurements, but is also connected with the fact that the measuring beam can only be directed very accurately into the tiny vapor capillary if said beam is not moved in a scanning manner. It may even be necessary to adjust the direction of the measuring beam accurately beforehand, so that enough measurement values from the base of the vapor capillary are obtained. Tests have shown that even the smallest maladjustments, such as are unavoidable in the case of a measuring beam that sweeps the vapor capillary in a scanner-like manner, drastically decreases the number of meaningful measurement points, and thereby the measuring accuracy as a whole.

Even if a very large number of measurement values from the vapor capillary are available and the measuring beam is satisfactorily adjusted, only relatively few meaningful measurement values are obtained, for reasons which have hitherto not been precisely known. In the case of a major portion of the measurement values, the measurement point does not seem to lie at the base of the vapor capillary, but above it. Only those measurement values which represent the largest distances actually provide information as to the site at which the base of the vapor capillary is located. For this reason, steps b) to c) are preferably repeated a number of times and there is selected, from measurement values for the first distance obtained from these, a quota of measurement values which represent the largest first distances. The actual depth of penetration can be deduced, for example by means of a regression analysis, from this quota of the measurement values.

If the measuring beam is directed into the vapor capillary, it is only possible, in this way, to determine the distance of the base of said vapor capillary from a reference point, which may be, for example, a zero point of the measurement, performed by the coherence tomograph, of the differences in path length. In order to be able to ascertain the depth of penetration, it is additionally necessary to measure how far away the surface of that region of the workpiece which surrounds the vapor capillary is from the reference point.

According to the invention, the optical coherence tomograph therefore generates a first measuring beam and a second measuring beam. The first measuring beam measures the distance of the reference point from the base of the vapor capillary, while the second measuring beam measures the distance of the reference point from the surface of that region on the workpiece which surrounds the vapor capillary. In general, the depth of penetration of the laser beam into the workpiece then emerges by simply establishing the difference between the two distance values. However, it may also be necessary to calculate the depth of penetration in a complicated manner. If it emerges, for example when checking the measurement results, that the depths of penetration measured generally differ from the actual depths of penetration by a factor or amount x, this can be taken into account in the calculation with the aid of a correction factor or amount. By means of a constant, but material-dependent amount (offset), it is possible, for example, to take account of the fact that the depth of a weld seam is, in general, somewhat greater than the depth of penetration, since the workpiece even also melts in a small region below the vapor capillary. In order to obtain accurate measurement values for the depth of penetration, the second measurement point on the surface of the workpiece, at which point the second measuring beam is directed, should not be too close to, but also not too far from, the vapor capillary. A distance of between 1 mm and 2.5 mm has turned out to be particularly suitable. The fact is, if the second measurement point is too close to the surface, it detects the surface of the melt, which surface is in violent motion or is emitting bubbles. If, on the other hand, the second measurement point is too far away from the vapor capillary, it may become necessary to draw on measurement values for determining the depth of penetration which were obtained at different points in time, or to take into account the shape of the surface in the vicinity of the vapor capillary by using data regarding the geometry of the workpiece which have been made available in some other way (for example an inclination of a plane face which is known from CAD data).

The second measurement points outside the vapor capillary may be used for regulating the distance between the machining head and the surface of the workpiece, as is known per se from the EP 1 977 850 A1 mentioned at the outset. In the course of this closed-loop control, it is ensured, by moving the machining head and/or the work-piece, that the focal spot of the laser beam is always located at the desired position relative to the surface of the workpiece. Alternatively or in addition, the focusing optical unit of the machining head may also be adjusted in order to position the focal spot relative to that surface of the workpiece which is being measured.

In step d), the second measuring beam can be directed successively at different second measurement points on the surface of the workpiece. The second measuring beam then has the function not only of supplying a reference value for determining the depth of penetration, but also, for example, of scanning the welding bead produced above the weld seam or of detecting the melt which surrounds the vapor capillary. In particular, at least some of the different second measurement points may cover a weld seam generated by the laser beam.

Under these circumstances, it has particularly proved to be favorable if at least some of the different second measurement points lie on a circle which encloses the vapor capillary. This guarantees that measurement points are always obtained in the forerun, irrespective of any traversing operation in which the relative arrangement between the laser beam and the workpiece is varied.

However, scanning is possible, not only in the case of the second measuring beam but, in addition, also in the case of the first measuring beam. This is expedient, particularly if the focal spot of the laser beam is also guided over the workpiece with the aid of a scanning apparatus which usually contains an arrangement of galvanic mirrors. If the machining head is sufficiently far away (for example about 50 cm from the workpiece) sites on the workpiece which lie a long way apart can be machined extremely quickly by the laser beam. Under these circumstances, the comparatively large movements of the relatively heavy machining head are replaced by short, rapid movements of the light galvanic mirrors in the scanning apparatus. Methods of machining in which the machining head is located a long way away from the workpiece and said machining head contains a scanning apparatus are often described as “remote welding” or “welding-on-the-fly” or “remote laser cutting”. The independent scanning, according to the invention, of the vapor capillary and the surrounding region can also be used advantageously for methods of this kind. In order to be able to cover a larger axial measuring range, there may be arranged in the reference arm of the coherence tomograph a path-length modulator which tracks the optical path length in the reference arm synchronously with, and in dependence on, a variation in the focal length of the focusing optical unit. For further details on this subject, the reader is referred to Patent Application DE 10 2013 008 269.2 which was filed on 15 May 2013.

In general it is favorable if the first measuring beam, which is directed at the base of the vapor capillary, passes through a focusing optical unit of the machining head coaxially with the laser beam. This guarantees that the first measurement point associated with the first measuring beam is always located in the focal spot of the laser beam or in the immediate vicinity thereof. Since the base, which is to be scanned, of the vapor capillary is located in the immediate vicinity of the focal spot of the laser beam, this leads to the fact that even the first measuring beam has its maximum intensity at that point. This has a favorable effect on the signal-to-noise ratio and thereby on the measuring accuracy. This is particularly important in the case of the remote machining methods mentioned above, in which the focusing optical unit has to have a variable focal length.

In principle, it is possible to have the first measuring beam and the second measuring beam generated by two mutually independent partial systems of the optical coherence tomograph.

Since, however, optical coherence tomographs are capable of measuring distances from a number of optical boundary surfaces simultaneously, it is more favorable if the first measuring beam and the second measuring beam pass through at least one optical element of the optical coherence tomograph together or use said element jointly in some other way. The constructional expenditure on the coherence tomograph can be reduced by such joint use of optical elements. It is particularly favorable if the measuring light generated by the optical coherence tomograph is divided into the first measuring beam and second measuring beam only in an objective arm of the coherence tomograph. It is then possible to use at least the more expensive components of the optical coherence tomograph, such as, for instance, the spectrometer it contains, for both measuring beams.

Steps a) to e) are preferably performed simultaneously. The measurement with the aid of the two measuring beams and the machining of the workpiece with the aid of the laser beam then take place simultaneously.

By means of the method according to the invention, it becomes possible to vary at least one parameter of the laser machining operation, in particular the output of the laser beam or the location of the focal spot relative to the workpiece, in dependence on the depth of penetration determined in step e). The depth of penetration measured can thus be directly used to influence the laser machining operation in such a way that qualitatively high-grade machining results are achieved. In particular, it is possible to feed the depth of penetration determined in step e) as a measured variable to a closed-loop control circuit for regulating the depth of the vapor capillary.

If, in the provision according to the invention of a first measuring beam, which is preferably directed permanently at the base of the vapor capillary, an adjustment of the first measurement point is necessary, it is possible to vary, in an automatic adjusting step, the location of said first measurement point with the aid of a positioning element acting on the first measuring beam, until the quota of utilisable distance-measurement values is at its maximum. An adjusting step of this kind may be performed at regular chronological intervals or may even precede each machining operation. Under these circumstances, the adjusting step may be performed, for example, at a test-machining point on the workpiece at which a vapor capillary is generated merely for the purpose of adjusting the laser beam.

The invention also provides a laser machining device which is set up for machining a workpiece with a laser beam and is suitable for performing the method according to the invention. The laser machining device has a focusing optical unit which is set up for focusing the laser beam in a focal spot. Said laser machining device also has an optical coherence tomograph which is set up for directing a first measuring beam at a first measurement point at the base of the vapor capillary which has been generated on the workpiece by the focal spot, and thereby measuring a first distance between a reference point and the first measurement point. The optical coherence tomograph is also set up for simultaneously directing a second measuring beam at a second measurement point on a surface of the workpiece outside the vapor capillary, and thereby measuring a second distance between the reference point and the second measurement point. The laser machining device also has an evaluating apparatus which is set up for determining the depth of penetration of the laser beam from the first distance and the second distance.

There may be arranged, in an objective arm of the coherence tomograph, a scanning apparatus which is set up for directing the second measuring beam successively at different second measurement points on the surface of the workpiece.

The first measuring beam preferably passes through the focusing optical unit coaxially with the laser beam. Said focusing optical unit may have a variable focal length so that the first measuring beam is always focused by the focusing optical unit in the same focal plane in which the focal spot of the laser beam is also located.

It is particularly favorable if the optical coherence tomograph operates in the frequency domain (FD-OCT). Coherence tomographs of this kind have a large axial measuring range and require no optical path-length modulators in the reference arm.

### BRIEF DESCRIPTION OF THE DRAWINGS

Various features and advantages of the present disclosure may be more readily understood with reference to the following detailed description taken in conjunction with the accompanying drawing in which:

FIG. 1 shows a diagrammatic representation of a laser machining device according to the invention in accordance with a first embodiment, when welding two workpieces together;

FIG. 2 shows the internal design of the laser machining device shown in FIG. 1, in a diagrammatic representation;

FIGS. 3a and 3b show enlarged meridional sections through a rotating wedge plate which is contained in the laser machining device;

FIG. 4 shows an enlarged cutout from the workpieces, in which the vapor capillary can be seen;

FIG. 5 shows a top view of the cutout shown in FIG. 4;

FIG. 6 shows a representation, which is simplified compared with FIG. 4, in the case of workpieces having varying thicknesses;

FIG. 7 shows a graph in which distance measurement values are plotted over time t;

FIG. 8 shows a graph in which the depth of penetration is plotted as a function of time;

FIG. 9 shows a graph in which there are plotted measurement values which have been obtained using a coherence tomograph according to the prior art, in which a single measuring beam sweeps the workpiece in a scanning manner;

FIG. 10 shows the internal design of a laser machining device according to the invention in accordance with a second embodiment, in a diagrammatic representation based on FIG. 2;

FIG. 11 shows an enlarged cutout from the workpieces for the embodiment shown in FIG. 10, in a sectional representation based on FIG. 4;

FIG. 12 shows the internal design of a laser machining device according to the invention in accordance with a third embodiment, in a diagrammatic representation based on FIG. 2; and

FIGS. 13a and 13b show meridional sections through a rotating optical element which is contained in the laser machining device according to the third embodiment.

### DESCRIPTION OF PREFERRED EMBODIMENTS

### 1. Design of the Laser Machining Device

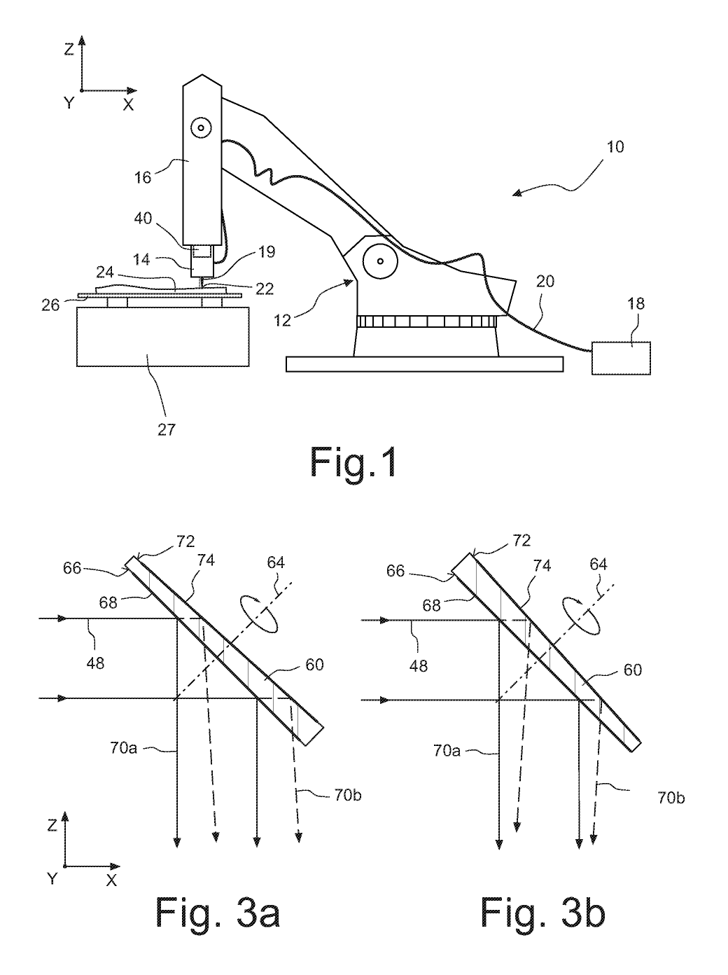

FIG. 1 shows, in a diagrammatic representation, an embodiment of a laser machining device 10 according to the invention, which comprises a robot 12 and a machining head 14 which is fastened to a movable arm 16 of said robot 12.

The laser machining device 10 also includes a laser radiation source 18 which, in the embodiment represented, is constructed as a disc laser or fiber laser. The laser beam 19 generated by the laser radiation source 18 is fed, via an optical fiber 20, to the machining head 14 and is focused by the latter in a focal spot 22.

In the embodiment represented, the laser machining device 10 is to be used for the purpose of welding a first metallic workpiece 24 having varying thickness to a second metallic workpiece 26 which is fastened on a workpiece holder 27. The focal spot 22 generated by the machining head 14 must therefore be positioned precisely in the vicinity of the transition between the first workpiece 24 and the second workpiece 26.

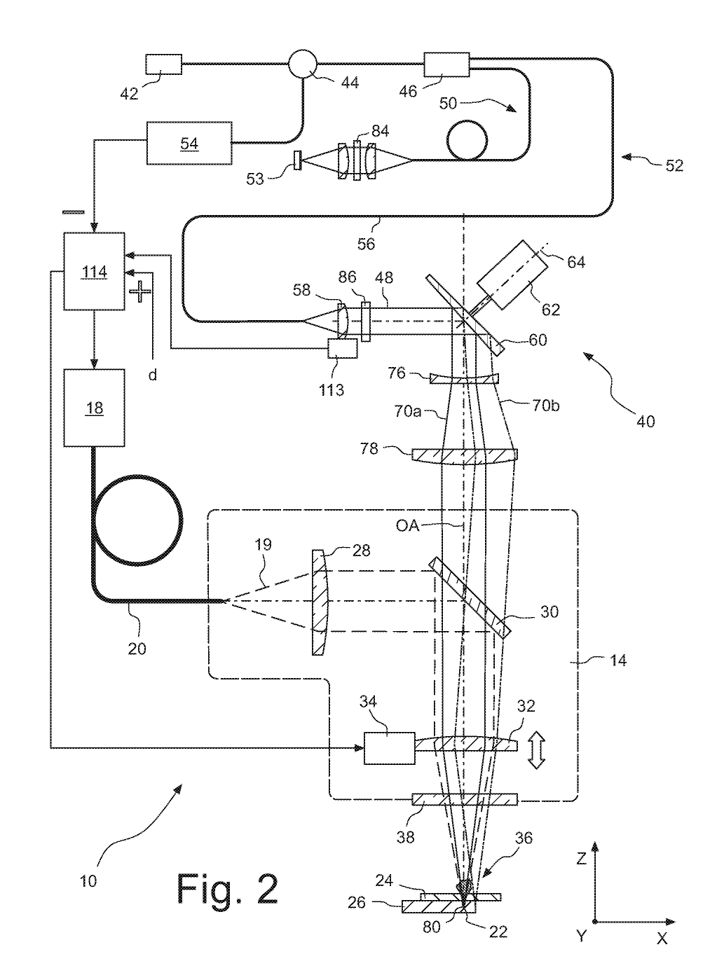

FIG. 2 shows the internal design of the laser machining device 10 in a diagrammatic representation. In the machining head 14, the laser beam 19 generated by the laser radiation source 18 passes out of the optical fiber 20 and is collimated by a first collimating lens 28. The collimated laser beam 19 is then deflected by 90° by a dichroic mirror 30 and impinges on a focusing optical unit 32, the focal length of which can be varied by axially shifting one or more lenses with the aid of a positioning drive 34. In this way, the axial location of the focal spot 22 can be varied by adjusting the focusing optical unit 32. The last optical element in the beam path of the laser beam 19 is a protective disc 38 which is fastened to the machining head 14 in an interchangeable manner and protects the other optical elements of said head against splashes and other contaminants which occur at a machining point indicated at 38.

The laser machining device 10 also comprises an optical coherence tomograph 40 which operates in the frequency domain (so-called “FD-OCT”). The coherence tomograph 40 has a light source 42, an optical circulator 44 and a fiber coupler 46 which divides measuring light 48 generated by the light source 42 into a reference arm 50 and an objective arm 52. In the reference arm 50, after passing along an optical path, which approximately corresponds to the optical path of the measuring light in the objective arm 52, said measuring light is reflected into itself at a mirror 53 and passes back to the optical circulator 44 which passes on the measuring light to a spectrograph 54.

In the objective arm 52, the measuring light passes out at the end of another optical fiber 56 and is collimated by a second collimator lens 58. The collimated measuring light 48 initially passes through a first Faraday rotator 86 which rotates the direction of polarization by 45°. A second Faraday rotator 84 of the same kind is arranged in the section of free beam diffusion in the reference arm 50. The two Faraday rotators 84, 86 have the function of avoiding disruptions which can occur if the optical fibers used in the coherence tomograph 40 do not obtain the state of polarization.

The collimated measuring light 48 then impinges on a wedge plate 60 which can be set in rotation about an axis of rotation 64 by a motor 62. As can be seen in the enlarged representation in FIG. 3a, the wedge plate 60 has a first plane face 66 which is oriented perpendicularly to the axis of rotation 64 and is provided with coating 68 which reflects about 50% of the incident measuring light 48. Since the plane face 66 does not change its orientation when a rotation of the wedge plate 60 occurs, it generates a first measuring beam 70a, the direction of which is likewise invariable.

The quota of measuring light 48 which passes through the partially reflective coating 68 impinges on a second plane face 72 of the wedge plate 60, which forms an angle, other than 90°, to the axis of rotation 64. The orientation of the second plane face 72 thus depends on the angle of rotation of the wedge plate 60. The second plane face 72 is provided with a completely reflective coating 74. Since the two plane faces 66, 72 are not parallel to one another, the second plane face 72 generates a second measuring beam 70b which has a different direction of diffusion from the first measuring beam 70a. Under these circumstances, the direction of diffusion depends on the angle of rotation of the wedge plate 60 with respect to the axis of rotation 64, as is illustrated in FIG. 3b. There, the wedge plate 60 has been twisted about the axis of rotation 64 by an angle of 180°, compared to the arrangement shown in FIG. 3a. When a rotation of the wedge plate 60 about the axis of rotation 64 occurs, the second measuring beam 70b therefore rotates continuously about the stationary first measuring beam 70a.

Reference will be made again below to FIG. 2, in order to explain the beam path of the two measuring beams 70a, 70b in greater detail. The measuring beams 70a, 70b, which are indicated by solid and double-dot-and-dash lines respectively, are initially widened out with the aid of a dispersing lens 76 and then collimated by a third collimator lens 78. After passing through the dichroic mirror 30, which is permeable in respect of the wavelengths of the measuring light, the measuring beams 70a, 70b are focused, just like the laser beam 19, by the focusing optical unit 32 and, after passing through the protective disc 38, are directed onto the workpieces 24, 26. Since the first measuring beam 70a is diffused coaxially with the laser beam 19, the focal spot 80 of the first measuring beam 70a coincides with the focal spot 22 of the laser beam 19, if disruptive effects such as chromatic aberration or errors of adjustment are disregarded. The focal plane of the second measuring beam 70b is coplanar with the focal plane of the laser beam 19 and of the first measuring beam 70a.

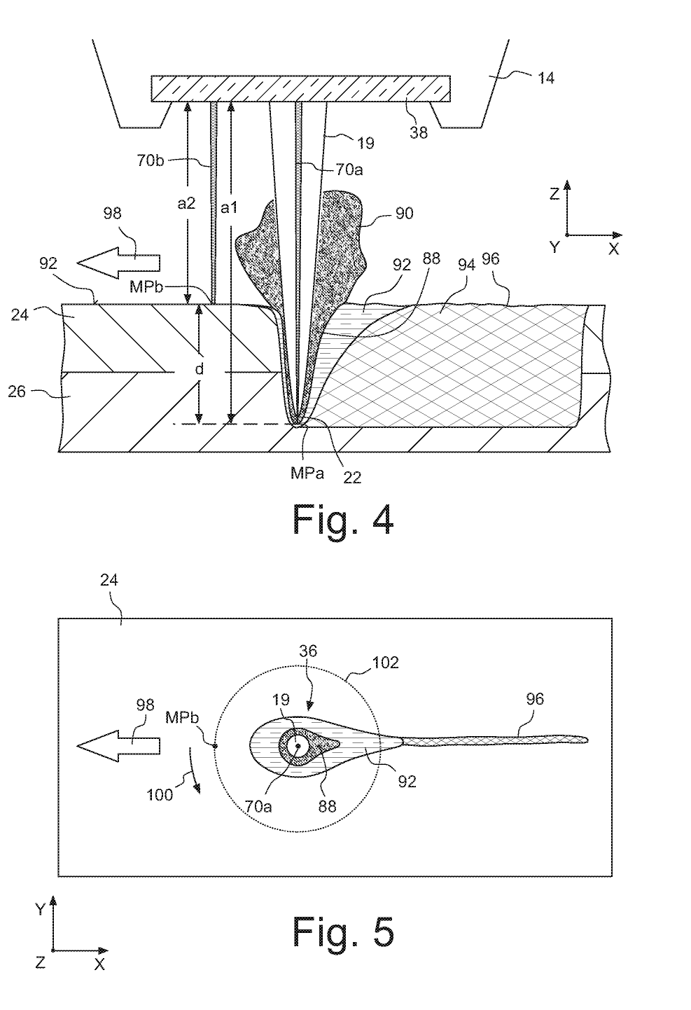

The conditions at the machining point 36 will be described in greater detail below with reference to FIG. 4. FIG. 4 shows an enlarged cutout from the workpieces 24, 26 which are to be welded to one another. The direction of traverse of the machining head 14 relative to the workpieces 24, 26 is designated by 98.

In the vicinity of the focal spot 22, the focused laser beam 19 passing out of the protective disc 38 reaches an energy density which is so high that the surrounding metal vaporizes and thereby forms a vapor capillary 88 which extends into the two workpieces 24, 26. Even if part of the vaporized metal forms a cloud 90 above the surface 92 of the first workpiece 24, only the cavity which develops below the surface 92 during the machining operation is designated as the vapor capillary 88.

Said vapor capillary 88 is surrounded by a melt 92 which solidifies as the distance from the focal spot 22 of the laser beam 19 increases. In the region of the melt 92, the materials of the two workpieces 24, 26 have connected to one another. When the melt 92 solidifies, this produces a weld seam 96, the upward-facing side of which is corrugated and is described as the “weld bead” 96.

In the enlarged representation in FIG. 4, it can be seen that the focal spot which is generated by the first measuring beam 70a approximately coincides with the focal spot 22 of the laser beam 19. In the vicinity of the focal spot 22, the first measuring beam 70a impinges, at the base of the vapor capillary 88, on the metallic melt 92 and is reflected back from that point into the objective arm 52 of the coherence tomograph 40. The point at which the first measuring beam 70a impinges on the base of the vapor capillary represents a first measurement point MPa which is associated with the first measuring beam 70a.

The point at which the second measuring beam 70b is reflected by that surface 92 of the first workpiece 24 which surrounds the vapor capillary 88 represents a second measurement point MPb which is associated with the second measuring beam 70b.

FIG. 5 shows a top view of the first workpiece 24 in the case of the cutout shown in FIG. 4. If the machining head 14 is moved along the direction of traverse 98 for the purpose of generating a weld seam 94, the weld bead 96 already mentioned is produced behind the vapor capillary 88 in the direction of traverse 98. An arrow 100 indicates how the second measurement point MPb rotates around the machining point 36 on a circular path 102 during a rotation of the wedge plate 60. Under these circumstances, the second measurement point MPb also sweeps part of the melt 92. If the wedge angle of the wedge plate 60 is chosen so as to be larger, the radius of the circle 102 increases. In this case, the second measurement point MPb may also sweep the weld bead 96. In this way, it is possible, with a measuring frequency of the coherence tomograph 40 in the order of magnitude of a few kHz, a frequency of rotation of the wedge plate 60 in the order of magnitude of 100 Hz and a speed along the direction of traverse 98 in the order of magnitude of 1 m/s, to scan the relief of the surface 92 in the area surrounding the machining point 36 with a high resolution.

### 2. Function

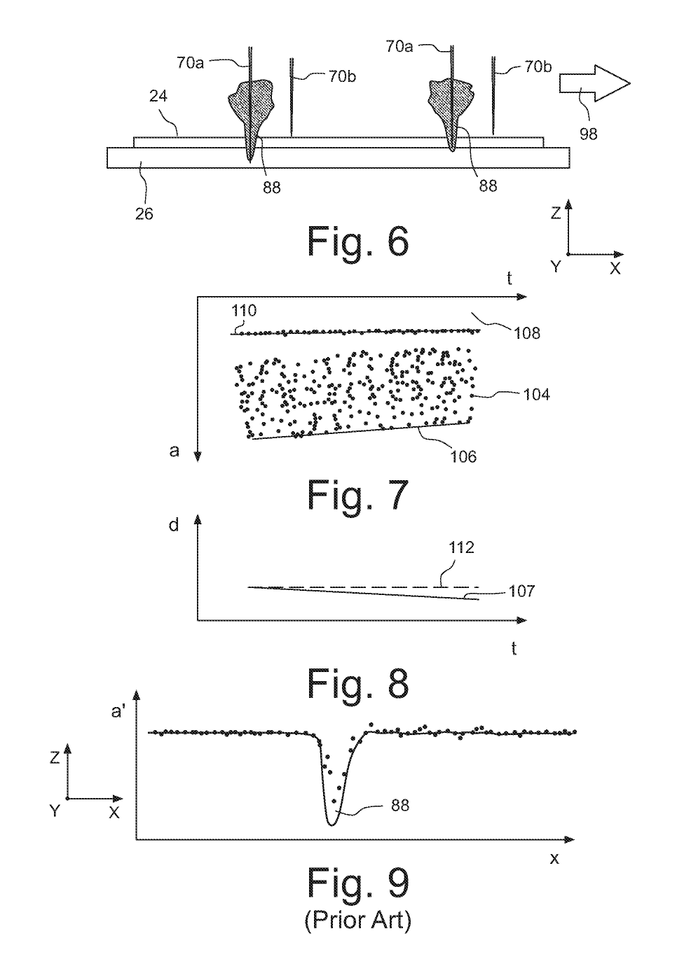

The functioning of the laser machining device 10 will be explained in greater detail below with reference to FIGS. 6 to 9.

In a first step, ideal values for the depth of penetration of the laser beam 19 are established. The depth of penetration is designated by d in FIG. 4 and is defined as the depth of the vapor capillary 88 below the surrounding (and still solid) surface 92 of the first workpiece 94. If the depth of penetration is too small, the two workpieces 24, 26 will not be welded, or will be welded only incompletely, to one another. If, on the other hand, the depth of penetration d is too great, full-penetration welding will occur.

In the case of plane workpieces of constant thickness, the depth of penetration d is, in general, constant. In general, however, the depth of penetration d depends on the coordinates x, y on the workpieces. Variations in the depth of penetration d may be necessary, for example if the thickness of the first workpiece 24 is site-dependent, as is illustrated in FIG. 6. Only if the depth of penetration d increases, as is indicated on the right in FIG. 6 by means of a broken line, can the first workpiece 24 having a wedge-shaped cross-section be welded to the second workpiece 26 with a quality that remains uniform.

In order to measure the depth of penetration d, the first measuring beam 70a measures, at the first measurement point MPa, the distance of the base of the vapor capillary 88 relative to a reference point which may be, for example, a point on the surface of the protective glass 38 through which the optical axis OA passes. In FIG. 4, this distance is designated by a1.

The second measuring beam 70b measures, at the second measurement point MPb, the distance, which is designated in FIG. 4 by a2, between the reference point and that surface 92 of the first workpiece 24 which surrounds the vapor capillary 88. The depth of penetration d then simply emerges as the difference between the distances a2 and a1. In order for this correlation to be valid, the second measurement point MPb associated with the second measuring beam 70b should be located close to, for example at a lateral distance of less than 2.5 mm and preferably less than 1 mm from, the vapor capillary 88, so that any steps or curvatures on the surface 92 of the first workpiece 24 do not falsify the measurement. However, it is also possible to take account of such steps or curvatures through the fact that, in determining the depth of penetration, measured values for the distance a2 are drawn upon which have been ascertained at a previous point in time when the second measurement point MPb was located at the coordinates x, y at which the first measurement point is now located. Then, as has already been mentioned above, the relief of the surface 92 of the first workpiece 24 is obtained by circular scanning of the area surrounding the machining point 36 by means of the second measuring beam 70b in combination with the traversing movement, that is to say both in the case of the state prior to machining with the laser beam 19 and also afterwards.

The finding of the distances a1, a2 with the aid of the coherence tomograph 40 takes place in a way which is conventional per se. After being reflected at the measurement points MPa, MPb, the measuring light 48 guided in the objective arm 52 enters said objective arm 52 again and passes, via the other optical fiber 56, back to the fiber coupler 46 and to the optical circulator 44. In the spectrograph 54, the reflected measuring light is overlaid with the measuring light which has been reflected in the reference arm 50. Interference of the measuring light reflected in the reference arm 50 and the measuring light reflected in the objective arm 52 occurs in the spectrograph 54. The interference signal is passed to a control and evaluating apparatus 114 (cf. FIG. 2) which calculates, from it, the optical path-length difference between the measuring light reflected in the reference arm 50 and the measuring light reflected in the objective arm 52. From this, it is possible to deduce the distances a1, a2 of the measurement points MPa, MPb from a common reference point.

At each point in time, two signal quotas are received in the spectrum, namely one for the first measurement point MPa and a second for the second measurement point MPb. A special feature in the performance of the method according to the invention consists in the fact that only the first measurement point MPa, but not the second measurement point MPb, lies on the optical axis OA.

FIG. 7 illustrates diagrammatically measurement values generated by the coherence tomograph 40 when the two measuring beams 70a, 70b are moved, along the direction of traverse 98, over the workpieces 24, 26 shown in FIG. 6 during a welding operation. The time t is represented on the abscissa and the distance a from the reference point is represented on the ordinate. The system of coordinates has been represented upside down in order to be able to better compare the distance values with the geometries, which are shown in FIG. 6, of the workpieces 24, 26.

An arrangement of first measurement values 104, which may be associated with the first measurement point MPa, is found in the lower region of the graph. It can be seen that the first measurement values 104 are scattered across a larger range of distances. Tests have shown that the first measuring beam 70a is often reflected before it reaches the base of the vapor capillary 88. The exact causes of this are not yet known in detail, since the operations in the vapor capillary 88 are complex and difficult to observe. It is possible that the vapor capillary 88 moves so quickly in the lateral direction during the laser machining operation that the first measuring beam 70a often impinges only on the lateral wall of said vapor capillary, but not on its base. Also conceivably possible as the cause are droplets of metal which form in the vapor capillary 88 as a result of condensation of the metal vapor or the release of splashes from the melt 92.

Investigations have shown that only the largest distance values in the graph in FIG. 7 represent the distance a1 from the base of the vapor capillary 88. A line of best fit 106 through these lower measurement points 104 thereby represents the distance function a1(t). Thus, use is made of only a quota of the largest depths of penetration d; the remaining measurement values for the first measurement point MPa are to be disegarded.

The second measurement values 108 that can be seen at the top in FIG. 7 were generated by the second measuring beam 70b at those points in time at which said second measuring beam 70b is located in front of the first measuring beam 70a in the direction of traverse 98. This state is illustrated in FIG. 5. A line of best fit through the second measurement values 108 thus supplies the function for the distance a2(t). At a given point in time t′, the depth of penetration d thus amounts to:

d=a2(t′)−a1(t′)

The chronological variation in the depth of penetration d(t) is represented in the graph in FIG. 8 by means of a solid line 107. The ideal depth of penetration dₜ(t) established beforehand for this welding operation is established by means of a broken line 112. It can be seen that the actual depth of penetration d(t) increasingly deviates from its ideal value in the course of the welding operation. The cause of this may be, for example, increasing contamination of the protective disc 38, as a result of which less and less laser radiation 19 reaches the workpieces 24, 26.

Deviations of the depth of penetration d from the ideal values can only be tolerated within predetermined limits. If these limits are exceeded, the output of the laser beam 19 is varied continuously or stepwise during the welding operation in order to prevent the limits from being exceeded.

For this reason, in the laser machining device 10 according to the invention, the ideal value for the depth of penetration d(t) is fed to the control and evaluating apparatus 114, which is in signal communication both with the laser radiation source 18 and with the focusing drive 34 of the focusing optical unit 32. In the embodiment represented, said control and evaluating apparatus 114 is part of a closed-loop control circuit to which the measured values for the depth of penetration are fed as a measured variable. The control and evaluating apparatus 114 compares the measured values for the depth of penetration d(t) with the ideal values dₜ(t) and regulates the output of the laser radiation source 18 in such a way that the measured depth of penetration d(t) deviates as little as possible from the ideal value. In addition, or as an alternative, to this, the focusing optical unit 32 may also be adjusted in such a way that the focal spot 22 of the laser beam 19 is shifted in the axial direction in order to, in this way, vary the depth of penetration d.

FIG. 9 illustrates, for comparison purposes, a measurement of the depth of penetration which is obtained if the machining point is conveyed away along the direction of traverse 98 during the welding operation with a single measuring beam. A solid line reproduces the actual geometry of the vapor capillary 88. It can be seen that so few measurement values are located in the region of the vapor capillary 88 that no reliable assertions can be arrived at as regards the depth of penetration. Only if the first measuring beam 70a is directed, in accordance with the invention, at the base of the vapor capillary 88 permanently or over a fairly long period of time, are measurement values obtained which permit reliable assertions concerning the depth of penetration, as has been explained above with reference to FIG. 7.

For accurate measurement of the distance a1 between the base of the vapor capillary 88 and the reference point, it may be necessary to adjust the direction of the first measuring beam 70a in a highly accurate manner before the start of the machining operation. Under these circumstances, the adjustment may take place, for example, by tilting one or more of the lenses 58, 76, 78 arranged in the objective arm 52. For the purpose of adjusting the lateral position of the measuring beams 70a, 70b, a transverse displacement of one of the lenses 76 or 78 is, in particular, a possibility. For the purpose of adjustment in the axial direction, the distance between the lenses 76 and 78 may be varied. This adjustment preferably takes place in an automatic adjusting step in which a vapor capillary 88 is initially generated by the laser beam 19 at a test-machining point, merely for adjustment purposes, and its depth is measured at the same time by means of the coherence tomograph 40. Under these circumstances, a positioning element 113 (cf. FIG. 2) connected to the control and evaluating apparatus 114 tilts the second collimator lens 58 until the first measurement point MPa is located at a position at which the maximum number of utilisable measurement values are obtained.

Instead of a tilting of the lens 58, other measures are also naturally possible in order to adjust the first measuring beam 70a. A mirror which is adjustable about two axes with the aid of actuators and which may also be designed as a MEMS mirror is particularly suitable for these purposes.

### 3. Alternative Embodiments

### a) Scanning Mirror

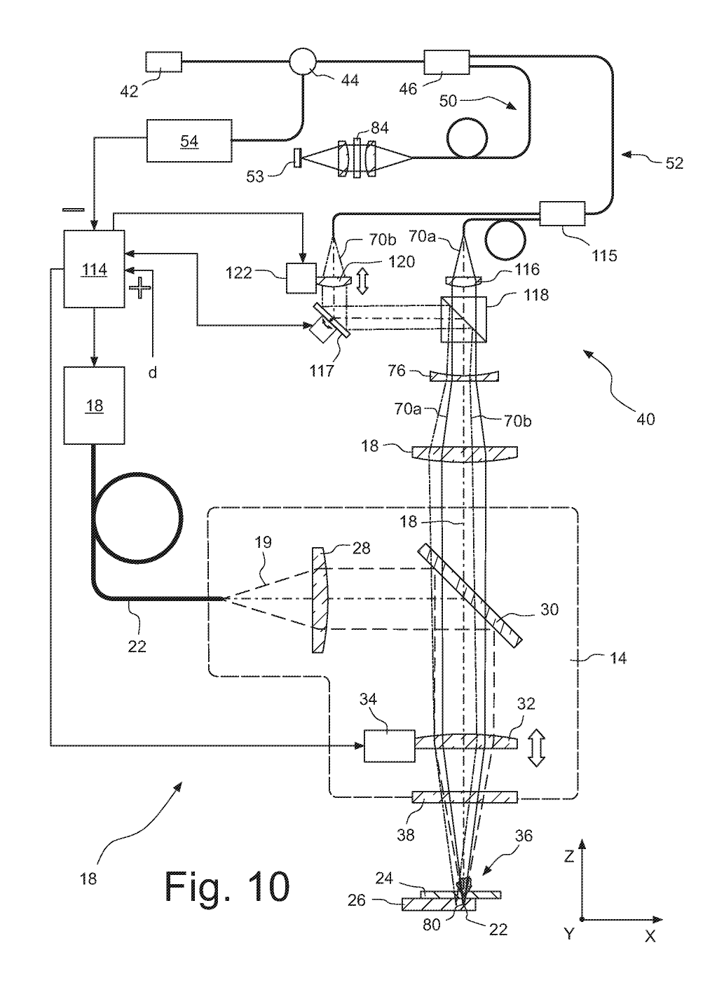

In a representation based on FIG. 2, FIG. 10 illustrates another embodiment for a laser machining device 10 according to the invention. Unlike the embodiment shown in FIG. 2, the two measuring beams 70a, 70b are not generated by a rotating wedge plate 60, but by a second fiber coupler 115. After collimation by a third collimator lens 116, the first measuring beam 70a passes through a beam-splitter cube 118 and is then focused again by the subsequent optical elements onto the first measurement point MPa in the vicinity of the focal spot 22, as has been explained above with reference to FIG. 2.

After collimation by a fourth collimator lens 120, the second measuring beam 70b decoupled from the second fiber coupler 115 impinges on a scanning mirror 117 which can be pivoted about both its Y axis and its X axis with the aid of actuators, of which no further details are represented. The pivoted second measuring beam 70b is coupled into the beam path of the first measuring beam 70a by the beam-splitter cube 118, and directed onto a second measurement point MPb. In contrast to the embodiment described in FIG. 2, the second measurement point MPb can thus be moved, not only on a circular path around the machining point 36, but can be guided in any desired manner over the region surrounding said machining point 36. This may be expedient, for example, if there is a particular interest in highly-resolved detection of the surface relief of the weld bead 96.

If the scanning mirror 117 is induced to vibrate at the natural frequencies, the second measurement point MPb describes, on the surface 92 of the second workpiece 24, Lissajous figures by means of which particularly rapid scanning, even of large areas, is possible.

In order to avoid losses of light at the second fiber coupler 115 and the beam-splitter cube 118, the second fiber coupler 114 may divide the measuring light entering it according to polarizations or wavelengths. If the second fiber coupler is polarization-selective, the beam-splitter cube 118 must also operate in a polarization-selective manner. If, on the other hand, the second fiber coupler is wavelength-selective, the beam-splitter cube 118 must also have a dichroic action.

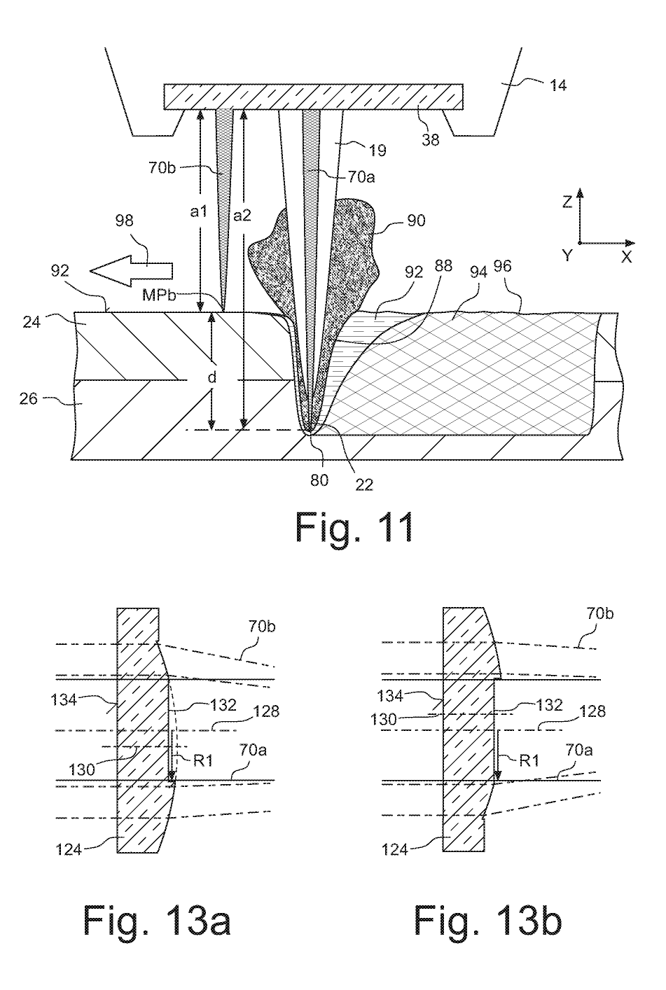

In FIG. 10 the fourth collimator lens 120, which collimates the second measuring beam 70b, is associated to an actuator 122 by means of which said fourth collimator lens 120 can be moved in the axial direction. In this way, it is possible to shift the axial location of the focal spot of the second measuring beam 70b. In particular, it is possible to position this focal spot precisely in the second measurement point MPb, as FIG. 11 illustrates. In this way, a more intense light reflex from the surface 92 of the workpiece 24 is obtained.

### b) Splitting in the Vicinity of the Pupil Plane

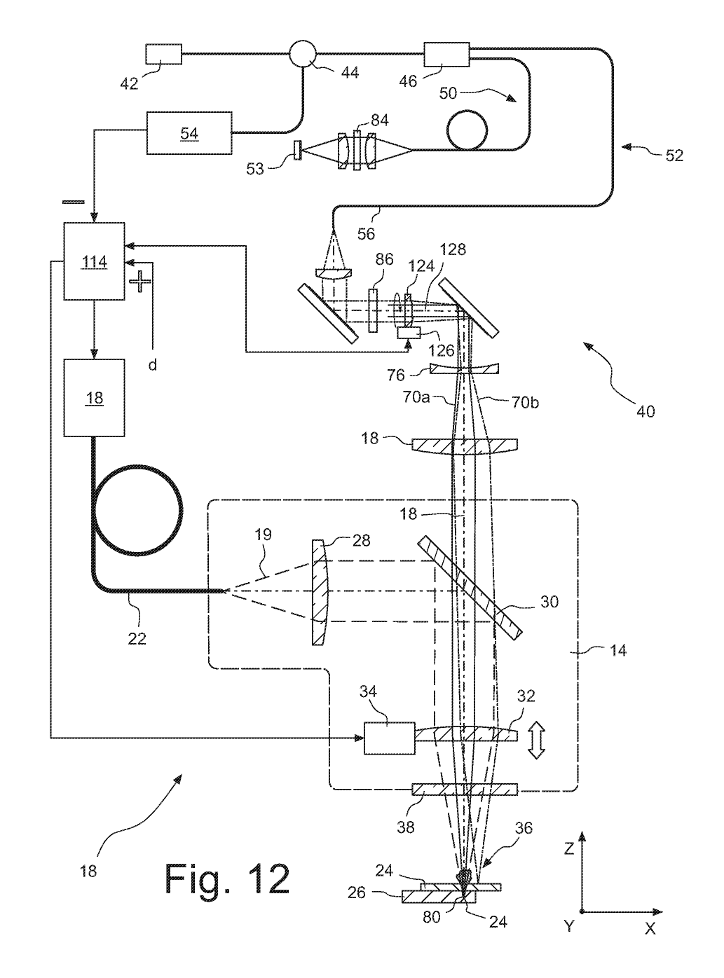

FIG. 12 shows a third embodiment for a laser machining device 10 according to the invention, in a representation which is likewise based on FIG. 2.

In the laser machining device 10 shown in FIG. 12, the two measuring beams 70a, 70b are generated by a special, aspherical optical element 124 which is located close to the pupil plane in the beam path of the measuring light 48. Under these circumstances, the optical element 124 is rotated by a drive 126, during a measuring operation, about an axis of rotation 128 which coincides with the optical axis.

FIGS. 13a and 13b show the optical element 124 in two rotational positions which differ from one another by an angle of rotation of 180°. Said optical element 124 has substantially the shape of a plane-convex lens with a spherical surface. In FIG. 13a, the axis of symmetry of this surface is designated by 130. In a manner which is off-center in relation to the axis of symmetry 130, but centered relative to the axis of rotation 128, the surface has a cylindrical recess 132 with a radius R1, the plane surface of which recess is parallel to the plane face 134 on the input side. For collimated measuring light which impinges on the optical element 124 at a distance r<R1 from the axis of rotation 128, the optical element 124 thus acts like a plane-parallel plate in all rotational positions.

For light which impinges on the optical element 124 at a distance r>R1, said element acts like a lens which has positive refractive power and is arranged in an off-center manner. Depending on the rotational position of the optical element 124, the measuring light is therefore deflected in different directions, as can be seen by comparing FIGS. 13a and 13b.

The measuring light passing through the cylindrical recess 132 forms the first measuring beam 70a, while the measuring light passing through the annular surrounding region forms the second measuring beam 70b. In a manner similar to the case of the rotating wedge plate 60 in the embodiment described in FIG. 2, the rotating optical element 124 thus generates a stationary first measuring beam 70a and a second measuring beam 70b which revolves around the first measuring beam 70a in the form of a circle.

Since the second measuring beam 70b passes through the convexly curved section of the optical element 124, the two measuring beams 70a, 70b are focused in different focal planes in the case of this embodiment too.

The above description has been given by way of example. From the disclosure given, those skilled in the art will not only understand the present disclosure and its attendant advantages, but will also find apparent various changes and modifications to the structures and methods disclosed. The applicant seeks, therefore, to cover all 5 such changes and modifications as fall within the spirit and scope of the disclosure, as defined by the appended claims, and equivalents thereof.

1. A method of measuring the depth of penetration of a laser beam into a work-piece, said method comprising the following steps:
a) focusing the laser beam in a focal spot with the aid of a focusing optical unit arranged in a machining head such that the focal spot generates a vapor capillary in the workpiece;
b) generating a first measuring beam and a second measuring beam by means of an optical coherence tomograph;
c) directing the first measuring beam at a first measurement point in the vapor capillary in order to thereby measure a first distance between a reference point and the first measurement point;
d) directing the second measuring beam at a second measurement point on a surface of the workpiece which faces the machining head and which is outside of the vapor capillary in order to thereby measure a second distance between the reference point and the second measurement point,
e) determining the depth of penetration of the laser beam from the first distance and the second distance
wherein between two consecutive measurements of the depth of penetration, the second measuring beam moves relative to the first measuring beam.

2. The method of claim 1, wherein the first measurement point is located at the base of the vapor capillary.

3. The method of claim 1, wherein steps b) to c) are repeated a number of times, thereby obtaining a number of measurement values for the first distance, and wherein a quota of measurement values is selected which represent the largest first distances.

4. The method of claim 1, wherein the second measurement point is at a lateral distance of less than 2.5 mm from an edge of the vapor capillary.

5. The method of claim 1, wherein, between the two consecutive measurements, the second measuring beam is directed to different second measurement points on the surface of the workpiece, wherein at least some of said different second measurement points lie on a circle which encloses the vapor capillary.

6. The method of claim 1, wherein the first measuring beam passes through the focusing optical unit of the machining head coaxially with the laser beam.

7. The method of claim 6, wherein the focusing optical unit has a variable focal length so that the first measuring beam is always focused by the focusing optical unit in the same focal plane in which the focal spot of the laser beam is also located.

8. The method of claim 1, wherein the first measuring beam and the second measuring beam jointly use at least one optical element of the optical coherence tomograph.

9. The method of claim 8, wherein measuring light generated by the optical coherence tomograph is split into the first measuring beam and the second measuring beam in an objective arm of the coherence tomograph.

10. The method of claim 1, wherein at least one parameter of the laser machining operation is varied in dependence on the depth of penetration determined in step e).

11. The method of claim 10, wherein the depth of penetration determined in step e) is fed, as a measured variable, to a closed-loop control circuit for controlling the depth of the vapor capillary.

12. The method of claim 1, wherein, in an automatic adjusting step, the location of the first measurement point is varied with the aid of a positioning element acting on the first measuring beam until a quota of utilizable distance-measurement values is at its maximum.

13. The method of claim 1, wherein the first measuring beam is stationary while the second measuring beam moves relative to the first measuring beam.

14. The method of claim 1, wherein measuring light generated by the optical coherence tomograph is split into the first measuring beam and the second measuring beam by an optical element that also causes the second measuring beam to move relative to the first measuring beam.

15. A method of measuring distances to a workpiece during a laser machining process, said method comprising the following steps:
a) focusing a laser beam in a focal spot such that the focal spot generates a vapor capillary in the workpiece;
b) generating a first measuring beam and a second measuring beam by means of an optical coherence tomograph;
c) directing the first measuring beam at a first measurement point in the vapor capillary in order to measure a first distance;
d) directing the second measuring beam at a second measurement point on a surface of the workpiece which is outside of the vapor capillary in order to measure a second distance,
e) while the first measuring beam is stationary, moving the second measuring beam relative to the first measuring beam so that the second measuring beam scans over the surface of the workpiece.

16. The method of claim 15, wherein measurement values for the first distance and for the second distance are fed to a closed-loop control circuit that controls at least one of the group consisting of: a parameter of the laser beam and a location of the focal spot.

17. The method of claim 15, wherein measuring light generated by the optical coherence tomograph is split into the first measuring beam and the second measuring beam by an optical element that also causes the second measuring beam to move relative to the first measuring beam.

18. A method of measuring distances to a workpiece during a laser machining process, said method comprising the following steps:
a) focusing a laser beam in a focal spot such that the focal spot generates a vapor capillary in the workpiece;
b) generating a first measuring beam and a second measuring beam by means of an optical coherence tomograph;
c) directing the first measuring beam at a first measurement point in the vapor capillary in order to measure a first distance;
d) directing the second measuring beam at a second measurement point on a surface of the workpiece which is outside of the vapor capillary in order to measure a second distance;
e) moving the first measuring beam over the vapor capillary until a quota of utilizable distance-measurement values has reached its maximum;
f) moving the second measuring beam relative to the first measuring beam so that the second measuring beam scans over the surface of the workpiece.

19. The method of claim 18, wherein measuring light generated by the optical coherence tomograph is split into the first measuring beam and the second measuring beam by an optical element that also causes the second measuring beam to move relative to the first measuring beam.
